(19) United States
(12) Patent Application Publication
(10) Pub. No.: US 2017/0221168 A1
(43) Pub. Date: Aug. 3, 2017

(54) DETERMINING RAYLEIGH BASED CONTEXTUAL SOCIAL INFLUENCE

(71) Applicant: INTERNATIONAL BUSINESS MACHINES CORPORATION, ARMONK, NY (US)

(72) Inventors: Aaron K. Baughman, Silver Spring, MD (US); Cameron McAvoy, Raleigh, NC (US); Brian M. O'Connell, Cary, NC (US)

(21) Appl. No.: 15/009,144

(22) Filed: Jan. 28, 2016

(51) Int. Cl. G06Q 50/26; G06Q 50/00; G06Q 30/02; H04W 4/02; G06F 17/30

(52) U.S. Cl. CPC G06Q 50/265; H04W 4/023; G06F 17/3053; G06Q 30/0205; G06Q 50/01; H04W 88/02

(57) ABSTRACT

An approach is provided for determining social influence. Measurements of social reach of social media content are determined. The content is being sent by mobile devices during an ongoing event that involves multiple individuals using social media via the mobile devices. The measurements of social reach include a rate of proliferation of the social media content. Social context features of the mobile devices during the event are determined. The social context features include geographic locations of the mobile devices at times at which the mobile devices send the social media content. A Rayleigh distribution is generated based on the measurements of social reach and the social context features. Based on the Rayleigh distribution, scores indicating respective social influences of the individuals are determined.

### BACKGROUND

The present invention relates to data analytics, and more particularly to determining and ranking influence of individuals in a social network.

Social media refers to a variety of Internet-based services that allow a large number of users to form online communities and to share information in an interactive manner. The Internet-based services include, for example, blogs, microblogs, and social networking sites. Social media is managed in a decentralized way by the general public, relying on content created by end users or the general public, as opposed to professionals. Messages posted via a social network service can be commented on, “liked”, or re-posted by members of the social network.

Organizations utilize existing data analysis techniques to perform Social Network Analysis (SNA) of social media data to extract and determine useful information, such as trends, trend setters, and influencers who influence other social media participants with regard to their opinions about companies or products.

### SUMMARY

In a first embodiment, the present invention provides a method of determining social influence. The method includes a computer determining measurements of social reach of social media content being sent by mobile devices during an ongoing event that involves multiple individuals using social media via the mobile devices. The measurements of social reach include a rate of proliferation of the social media content. The method further includes the computer determining social context features of the mobile devices during the event. The social context features include geographic locations of the mobile devices at times at which the mobile devices send the social media content. The method further includes the computer generating a Rayleigh distribution based on the measurements of social reach and the social context features. The method further includes based on the Rayleigh distribution, the computer determining scores indicating respective social influences of the individuals.

In a second embodiment, the present invention provides a computer program product including a computer-readable storage device and a computer-readable program code stored in the computer-readable storage device. The computer-readable program code includes instructions that are executed by a central processing unit (CPU) of a computer system to implement a method of determining social influence. The method includes a computer system determining measurements of social reach of social media content being sent by mobile devices during an ongoing event that involves multiple individuals using social media via the mobile devices. The measurements of social reach include a rate of proliferation of the social media content. The method further includes the computer system determining social context features of the mobile devices during the event. The social context features include geographic locations of the mobile devices at times at which the mobile devices send the social media content. The method further includes the computer system generating a Rayleigh distribution based on the measurements of social reach and the social context features. The method further includes based on the Rayleigh distribution, the computer system determining scores indicating respective social influences of the individuals.

In a third embodiment, the present invention provides a computer system including a central processing unit (CPU); a memory coupled to the CPU; and a computer-readable storage device coupled to the CPU. The storage device includes instructions that are executed by the CPU via the memory to implement a method of determining social influence. The method includes a computer system determining measurements of social reach of social media content being sent by mobile devices during an ongoing event that involves multiple individuals using social media via the mobile devices. The measurements of social reach include a rate of proliferation of the social media content. The method further includes the computer system determining social context features of the mobile devices during the event. The social context features include geographic locations of the mobile devices at times at which the mobile devices send the social media content. The method further includes the computer system generating a Rayleigh distribution based on the measurements of social reach and the social context features. The method further includes based on the Rayleigh distribution, the computer system determining scores indicating respective social influences of the individuals.

Embodiments of the present invention use a Rayleigh distribution to determine social influence to identify key influencers of an ongoing civil disturbance or other emergency event. The Rayleigh distribution allows for a first set of rules derived from historical data to be followed in identifying key influencers, while avoiding a need for subsequent and repeated calculations of mean and other statistical measurements, thereby speeding up determining and ranking of social influence and predicting future locations of the key influencers. By determining and ranking social influence and predicting future locations of key influencers in a timely manner, embodiments of the present invention provide a quick and cost-effective allocation of resources to locate key influencers and manage the activities of the key influencers or activities incited by the key influencers.

### BRIEF DESCRIPTION OF THE DRAWINGS

FIG. 1 is a block diagram of a system for determining social influence, in accordance with embodiments of the present invention.

FIG. 2 is a flowchart of a process for determining social influence, where the process is implemented in the system of FIG. 1, in accordance with embodiments of the present invention.

FIG. 3 is a flowchart of a process for predicting a location of a key influencer, where the process is implemented in the system of FIG. 1, in accordance with embodiments of the present invention.

FIG. 4 is a block diagram of a computer that is included in the system of FIG. 1 and that implements the processes of FIG. 2 and FIG. 3, in accordance with embodiments of the present invention.

### DETAILED DESCRIPTION

### Overview

Embodiments of the present invention recognize that effectively and quickly allocating resources to address ongoing emergencies or crises that involve large groups of people presents unique challenges to governmental bodies, including law enforcement bodies. Law enforcement bodies may need to allocate resources to maintain public order in response to a riot. A riot is a civil disturbance characterized by a group acting in a violent manner against authority, property or people in response to a perceived grievance or out of dissent. Identifying a leader of a riot or other civil disturbance and predicting a future location of an identified leader facilitate a quick, cost-effective, and appropriate use of law enforcement resources.

Determining an amount of influence and the ranking of influence an individual has in a social situation such as an emergency or crisis situation is important to understand current and future social situations. Embodiments of the present invention utilize a Rayleigh distribution for two independent social vectors (i.e., social reach and social context measures) to determine measures of social influence and rank the social influence of individuals in a social situation, including an ongoing emergency or crisis situation involving a large group of people. The Rayleigh distribution provides a measurement of contextualized social reach. To use the Rayleigh distribution, the distribution over each component is determined to be normal and centered (i.e., take the z score of every sample), and each measurement is tested to verify the measurement is independent. Using the Rayleigh distribution combines current and predictive methods and allows a determination of relative social influence of individuals that changes over time.

In one embodiment, the Rayleigh distribution is used to provide confidence estimates to identify individual(s) (i.e., leader(s) or key influencer(s)) having the highest rank(s) of social influence among a group of people that are in a location in which a riot is taking place identifies likely leader(s) of the riot. By identifying the likely leaders of the riot and identifying their locations, law enforcement resources can be efficiently and quickly allocated to curb further unlawful actions incited by the leaders, thereby avoiding negative social and economic consequences such as property destruction.

Embodiments of the present invention also recognize that the social influence of an individual may not directly correlate with (1) the individual's social influence score as determined by existing influence ranking systems provided by media analytic services such as Klout® media analytic service which provides a “klout score” indicating social influence, (2) the number of followers the individual has, or (3) the directly observable social reach of the individual. Klout is a registered trademark of Klout, Inc. located in San Francisco, Calif. Existing influence ranking systems provide a social influence score based on the size of an individual's social network (e.g., number of followers, friendship links, etc.), a likelihood of generating action by other users (e.g., in the form of replying to or commenting on the message generated by the individual, liking the message, sharing the message, etc.) in response to the individual posting a message on a social media service, and an influence value of the individual's engaged audience.

Embodiments of the present invention further recognize that existing ranking systems may overweight non-credible sources and underweight credible sources when measuring social influence. Credibility of entities using social media varies widely. For example, celebrity figures are likely to wield disproportionate social reach, but they often lack the credibility to directly influence their followers. In contrast, state or national agencies may have fewer followers but more credibility than the celebrity figures. For example, tweets from a more credible state or national agency may directly influence the agency's followers to take immediate action in response to an emergency or crisis, whereas tweets from a less credible celebrity may have little or no influence on the celebrity's followers to take a similar immediate action.

### System for Determining Social Influence and Predicting Locations of Key Influencers

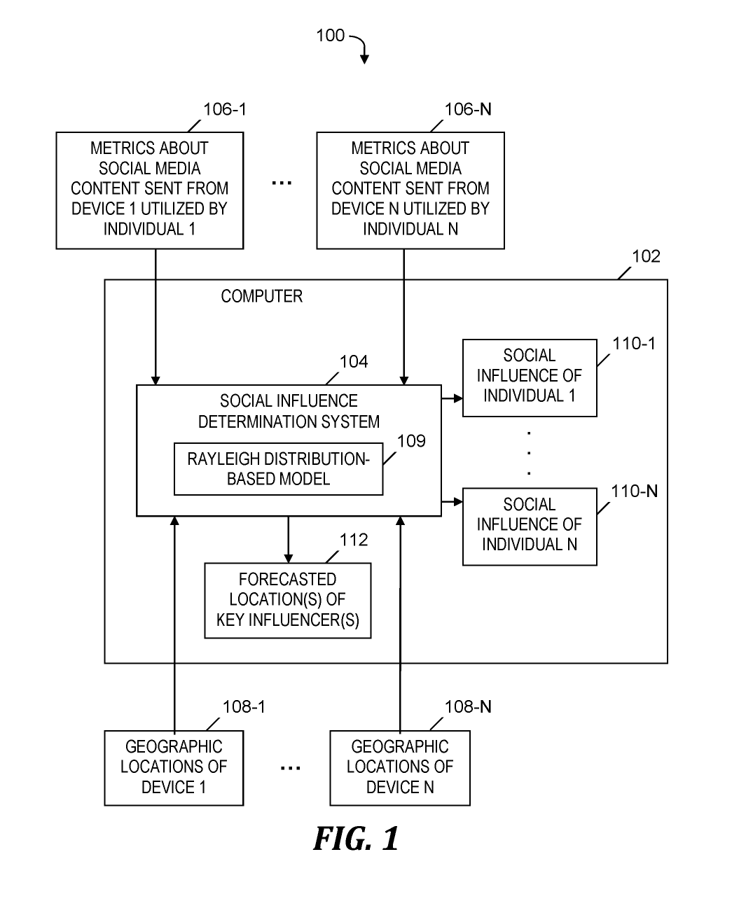

FIG. 1 is a block diagram of a system for determining social influence, in accordance with embodiments of the present invention. System 100 includes a computer 102 which executes a software-based social influence determination system 104.

Social influence determination system 104 receives data (not shown) specifying an ongoing event in which multiple individuals are participating, where the individuals are sending and receiving social media content via mobile devices or other computing devices. The data specifying the event indicates a geographic area in which the event is occurring.

During the event, social influence determination system 104 receives or determines metrics 106-1 about social media content sent from device 1 utilized by individual 1, . . . , metrics 106-N about social media content sent from device N utilized by individual N, where N is an integer greater than or equal to two. Metrics 106-1, . . . , 106-N includes measurements of the respective velocities, accelerations, sentiments, or popularity of the social media content sent from device 1, . . . , social media content sent from device N.

During the ongoing event, social influence determination system 104 receives geographic locations 108-1 of device 1, . . . , geographic locations 108-N of device N, where the received geographic locations are determined by a navigation system such as Global Positioning System (GPS) receivers coupled to respective devices 1, . . . , N. The received geographic locations of one of devices 1, N are geographic locations of the device at different times during which the event is occurring. In one embodiment, each of the geographic locations included in geographic locations 108-1, . . . , 108-N include latitude and longitude coordinates.

During the event and using metrics 106-1, . . . , 106-N and geographic locations 108-1, . . . , 108-N, social influence determination system 104 generates a Rayleigh distribution-based model 109 of the social influence of the individuals participating in the aforementioned event. Based on the Rayleigh distribution-based model 109, social influence determination system 104 determines and ranks social influence 110-1 of individual 1, . . . , social influence 110-N of individual N. Based on the ranking of social influence 110-1, . . . , 110-N, social influence determination system 104 determines one or more of the multiple individuals who are key influencers (i.e., are likely to influence or incite actions performed by other individuals during the event). Based on the Rayleigh distribution-based model 109, social influence determination system 104 may determine forecasted location(s) 112 of the key influencer(s) during the event (i.e., predict geographic location(s) of the key influencer(s) at a specified future time).

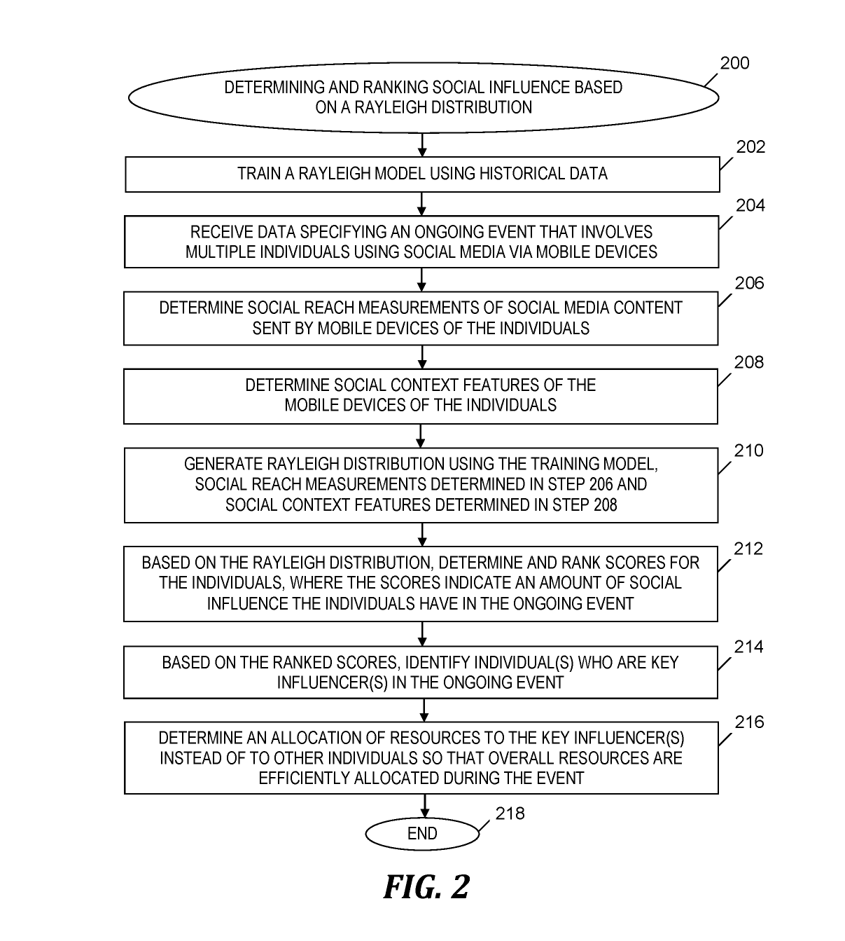

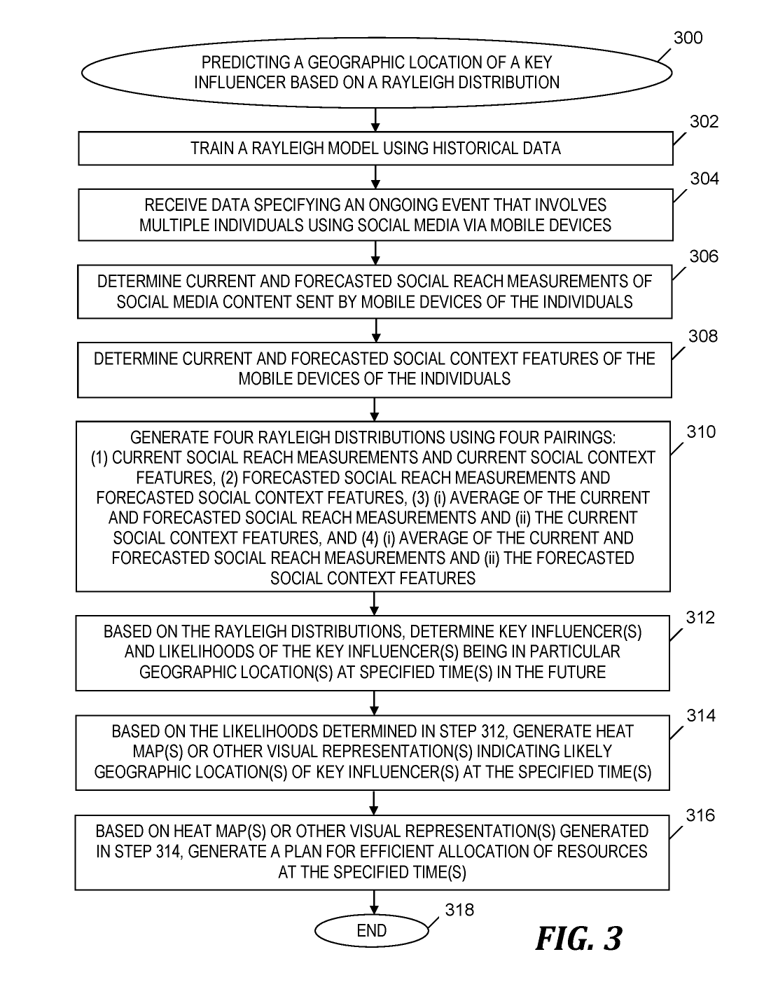

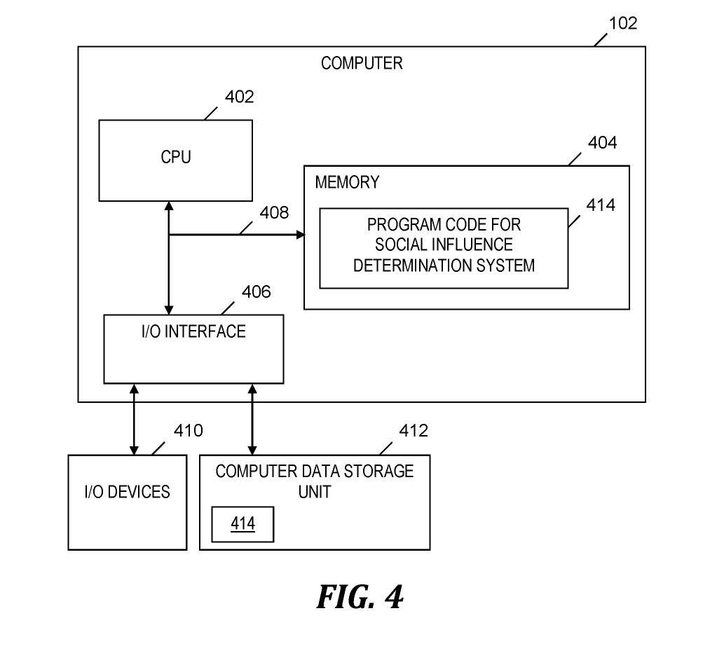

The functionality of the components shown in FIG. 1 is described in more detail in the discussions of FIG. 2, FIG. 3, and FIG. 4 presented below.

### Process for Determining Social Influence

FIG. 2 is a flowchart of a process for determining social influence, where the process is implemented in the system of FIG. 1, in accordance with embodiments of the present invention. The process of FIG. 2 starts at step 200. In step 202, social influence determination system 104 (see FIG. 1) trains a Rayleigh distribution-based model using historical data including metrics about social media content sent by mobile devices and geographic locations of the mobile devices during prior events.

In step 204, social influence determination system 104 (see FIG. 1) receives data specifying an ongoing event which has attributes, such as a geographic location of the event or a size of a geographic area in which the event is occurring, which are similar to attributes of the aforementioned prior events. The ongoing event has N individuals participating in the event, where N is an integer greater than or equal to two. The N individuals are utilizing respective mobile devices or other computing devices. Each of the mobile devices sends social media content to and/or receives social media content from one or more of the other mobile devices being utilized by other individuals who are current participants in the ongoing event. Each of the mobile devices may send the social media content to one or more other individuals who are not current participants, but are possible participants in the event at a time in the future.

In step 206, social influence determination system 104 (see FIG. 1) determines measurements of social reach of the social media content sent from devices 1, N during the event. The measurements of social reach include metrics 106-1, . . . , 106-N (see FIG. 1), which are metrics about, respectively, social media content sent from device 1 utilized by individual 1, . . . , social media content sent from device N utilized by individual N.

In step 208, social influence determination system 104 (see FIG. 1) determines social context features of the mobile devices being utilized by the N individuals during the event. The social context features include the geographical locations 108-1, . . . , 108-N (see FIG. 1) of devices 1, N, respectively.

In step 210, based on the Rayleigh model trained in step 202, the measurements of social reach determined in step 206 and the social context features determines in step 208, social influence determination system 104 (see FIG. 1) generates Rayleigh distribution-based model 109 (see FIG. 1).

In one embodiment, social influence determination system 104 (see FIG. 1) follows steps 1 through 4 presented below to perform step 210.

Step 1: Social influence determination system 104 (see FIG. 1) calculates a social foresight value (i.e., forecasted social reach) by using weighted regression decay as presented in equation (1). The calculated social foresight indicates a degree of social influence an individual will have at a time in the future.

$$f ( {x}_{t} ) = ( 1 - {( {( \frac{1}{{f}_{a} ( {u}_{t} )} )}^{0.5} )}^{f ( {u}_{t} )} + ( \frac{r ( {u}_{t} )}{\sum r ( {u}_{{n}_{t}} ) } ) ) * t ( {u}_{t} ) * k ( {u}_{t} ) \qquad ( 1 )$$

where the calculation in the largest set of parentheses indicates the reach momentum, the first term being added in the largest set of parentheses is one minus the follower impact to the power of the number of tweet followers (or followers of other social media content), the ƒₐ function indicates an average number of followers of an individual participating in the event, the 0.5 power indicates the decay, the second term being added in the largest set of parentheses is the normalized number of retweets (or other forwarded social media content) by the individual, the r function indicates the retweets (or forwarding of other social media content) of the individual, the t function indicates tweets (or other social media content) sent by the individual, the function k indicates a klout score of the individual (or another social influence score provided by an existing social media analytic service), and where the subscript t indicates a window of time for which the function ƒ determines a velocity of social reach of the individual.

Social influence determination system 104 (see FIG. 1) calculates a current social reach value in equation (2) presented below, which indicates a velocity, acceleration, sentiment, or popularity of a tweet or other social media content sent from a device used by one of the individuals participating in the event. The social reach value also may indicate a likelihood of a tweet or other social media content to be rapidly and widely shared (i.e., go viral).

$$f ( x ) = ( 1 - {( {( \frac{1}{{f}_{a} ( u )} )}^{0.5} )}^{f ( u )} + ( \frac{r ( u )}{\sum r ( {u}_{n} ) } ) ) * t ( u ) * k ( u ) \qquad ( 2 )$$

where the calculation in the largest set of parentheses indicates the reach momentum, the first term being added in the largest set of parentheses is one minus the follower impact to the power of the number of tweet followers (or followers of other social media content) of an individual participating in the event, the ƒₐ function indicates an average number of followers of the individual, the 0.5 power indicates the decay, the second term being added in the largest set of parentheses is the normalized number of retweets (or other forwarded social media content) by the individual, the r function indicates the retweets (or forwarding of other social media content) of the individual, the t function indicates tweets (or other social media content) sent by the individual, and the function k indicates a klout score of the individual (or another social influence score provided by an existing social media analytic service).

In an alternate embodiment, the function k used in equations (1) and (2) presented above includes a measurement of credibility of each individual. Credibility may be inferred by social influence determination system 104 (see FIG. 1) analyzing other individuals' replies and responses to tweets or other social media content that had been authored by the individual. The analysis of the replies and responses includes natural language processing to infer the emotional content and sentiment of the replies and responses, thereby determining whether the individual who authored the tweet or other social media content is being taken seriously by the recipients. A measurement of higher credibility is an indicator of an individual being more likely to be a key influencer.

Social influence determination system 104 (see FIG. 1) combines the results of equations (1) and (2) with any standard harmonic mean or other averaging technique to obtain a final social reach value.

Step 2: Social influence determination system 104 (see FIG. 1) uses the haversine formula, as presented below in equations (3), (4), and (5), to calculate social context features of the social media content as an average distance of the locations at which tweets or other social media content originated to an epicenter of the event. In equation (5) presented below the calculated value d is the great-circle distance between first and second geographic points on the earth (i.e., between the point at which social media content originated and the point that is given or determined as the epicenter of the event).

a=sin²(Δφ/2)+cos φ₁·cos φ₂·sin²(Δλ/2) (3)

c=2·atan2(\sqrt{a}\sqrt{(1−a)}) (4)

d=R·c (5)

where atan2 is the arctangent function, Δφ is the difference in the latitudes of the first and second geographic points, Δλ is the difference in the longitudes of the first and second geographic points, φ₁ is the latitude of the first geographic point, φ₂ is the latitude of the second geographic point, R is the earth's radius (where the mean radius of the earth is 6,371 kilometers), a is the square of half the chord length between the two geographic points, and c is the angular distance between the two geographic points in radians.

In an alternate embodiment, social influence determination system 104 (see FIG. 1) determines social context features by generating a matrix which is represented by the vertices of a polygon. Social influence determination system 104 (see FIG. 1) represents each point on the polygon by latitude and longitude of a tweet. The magnitude of a tweet is measured by the area within the polygon.

Step 3: Social influence determination system 104 (see FIG. 1) ensures that the components in the results of Steps 1 and 2 are Gaussian distributed and centered at zero, and then starts to generate a Rayleigh distribution using the social reach values from Step 1 and the social context features from Step 2, by creating a two-dimensional vector as shown in equation (6) presented below.

Y=(U,V) (6)

where U is the result from Step 1 and V is the result from Step 2 by determining the mean, variation, and standard deviation of each component in the results of Steps 1 and 2. The standard deviation is determined based in part on selecting a good fit for the training data used in step 202.

Social influence determination system 104 (see FIG. 1) generates the functions in equations (7) and (8) presented below.

$$\begin{matrix}{f}_{U} ( u ; σ ) = \frac{{e}^{- {u}^{2} / 2 {σ}^{2}}}{\sqrt{2 {πσ}^{2}}} & ( 7 ) \\ {f}_{V} ( v ; σ ) = \frac{{e}^{- {v}^{2} / 2 {σ}^{2}}}{\sqrt{2 {πσ}^{2}}} & ( 8 )\end{matrix}$$

With x as the length of Y defined in equation (6) presented above, social influence determination system 104 (see FIG. 1) calculates the distribution as shown in equation (9) presented below.

$$f ( x ; σ ) = \frac{1}{2 {πσ}^{2}} {\int }_{- ∞}^{∞} du {\int }_{- ∞}^{∞} {dve}^{- {u}^{2} / 2 {σ}^{2}} {e}^{- {v}^{2} / 2 {σ}^{2}} δ ( x - \sqrt{{u}^{2} + {v}^{2}} ) \qquad ( 9 )$$

Social influence determination system 104 (see FIG. 1) transforms equation (9) into a polar coordinate system version in equation (10) presented below, which is an expression of the probability density function of the Rayleigh distribution.

$$f ( x ; σ ) = \frac{x}{{σ}^{2}} {e}^{- {x}^{2} / 2 {σ}^{2}} \qquad ( 10 )$$

In step 212, based on Rayleigh distribution-based model 109 (see FIG. 1) generated in step 210, social influence determination system 104 (see FIG. 1) determines and ranks respective social influence scores for the N individuals, where the scores indicate respective amounts of social influence the individuals have on inciting actions by other individuals participating in the ongoing event.

In one embodiment, social influence determination system 104 (see FIG. 1) determines the social influence scores in step 212 from the probability density function in equation (10) presented above. A probability value of the score indicates a confidence level that the individual is a key influencer among the multiple individuals participating in the event.

In one embodiment, social influence determination system 104 (see FIG. 1) uses a scaling factor sigma of less than 0.5 to minimize false positives.

In step 214, based on the scores determined and ranked in step 212, social influence determination system 104 (see FIG. 1) identifies one or more of the N individuals who are key influencer(s) in the ongoing event. The social influence scores that exceed a specified threshold score indicate individuals who are key influencers.

In step 216, social influence determination system 104 (see FIG. 1) determines that an allocation of resources is made to the key influencer(s) identified in step 214 instead of to other individuals participating in the ongoing event, in order to prevent or otherwise manage activities of the other individuals, where the activities are incited by the key influencer(s). The allocation of resources to the key influencer(s) ensures that overall resources are allocated during the ongoing event in a timely and cost-effective manner.

The process of FIG. 2 ends at step 218.

### Process for Predicting a Geographic Location of a Key Influencer

FIG. 3 is a flowchart of a process for predicting a location of a key influencer, where the process is implemented in the system of FIG. 1, in accordance with embodiments of the present invention. The process of FIG. 3 starts at step 300. In step 302, social influence determination system 104 (see FIG. 1) trains a Rayleigh distribution-based model using historical data including metrics about social media content sent by mobile devices during prior events and geographic locations of the mobile devices during the prior events.

In step 304, social influence determination system 104 (see FIG. 1) receives data specifying an ongoing event which has attributes, such as a geographic location or a size of a geographic area in which the event is occurring, which are similar to attributes of the aforementioned prior events. The ongoing event has N individuals participating in the event, where N is an integer greater than or equal to two. The N individuals are utilizing respective mobile devices or other computing devices. Each of the mobile devices sends social media content to and/or receives social media content from one or more of the other mobile devices being utilized by other individuals who are current participants in the ongoing event. Each of the mobile devices may send the social media content to one or more other individuals who are not current participants, but who may participate in the event at a time in the future.

In step 306, social influence determination system 104 (see FIG. 1) determines current and forecasted measurements of social reach of the social media content sent from devices 1, N during the event. The measurements of social reach include metrics 106-1, . . . , 106-N (see FIG. 1), which are metrics about, respectively, social media content sent from device 1 utilized by individual 1, . . . , social media content sent from device N utilized by individual N.

In step 308, social influence determination system 104 (see FIG. 1) determines current and forecasted social context features of the mobile devices being utilized by the N individuals during the event. The social context features include current and forecasted geographical locations 108-1, . . . , 108-N (see FIG. 1) of devices 1, N, respectively.

In step 310, based in part on the Rayleigh model trained in step 202, social influence determination system 104 (see FIG. 1) generates four Rayleigh distributions using four pairings of data: (1) current measurements of social reach determined in step 306 and current social context features determined in step 308; (2) forecasted measurements of social reach determined in step 306 and forecasted social context features determined in step 308; (3) current social context features determined in step 308 and an average of current and forecasted measurements of social reach determined in step 306; and (4) forecasted social context features determined in step 308 and an average of current and forecasted measurements of social reach determined in step 306.

In step 312, based on the four Rayleigh distributions generated in step 310, social influence determination system 104 (see FIG. 1) determines key influencer(s) among the multiple individuals participating in the event and determines likelihoods of the key influencer(s) being in particular geographic location(s) at specified time(s) in the future.

In one embodiment, the current and forecasted social reach measurements determined in step 306, the current and forecasted social context features determined in step 308, the Rayleigh distributions generated in step 310, and the key influencer(s) determined in step 312 use the equations (1) through (10) described above relative to the discussion of FIG. 2.

In step 314, based on the likelihoods determined in step 312, social influence determination system 104 (see FIG. 1) generates heat map(s) or other visual representation(s) indicating likely geographic location(s) of the key influencer(s) determined in step 312 at the specified time in the future.

In step 316, based on the heat map(s) or other visual representation(s) generated in step 314, social influence determination system 104 (see FIG. 1) generates a plan for an efficient, cost-effective allocation of resources at the specified time(s) to prevent or otherwise manage action(s) by other individuals participating in the event, where the action(s) are incited by the key influencer(s).

### Computer System

FIG. 4 is a block diagram of a computer that is included in the system of FIG. 1 and that implements the processes of FIG. 2 and FIG. 3, in accordance with embodiments of the present invention. Computer 102 is a computer system that generally includes a central processing unit (CPU) 402, a memory 404, an input/output (I/O) interface 406, and a bus 408. Computer 102 is coupled to I/O devices 410 and a computer data storage unit 412. CPU 402 performs computation and control functions of computer 102, including executing instructions included in program code 414 for social influence determination system 104 (see FIG. 1) to perform a method of determining social influence and/or a method of predicting a geographic location of a key influencer, where the instructions are executed by CPU 402 via memory 404. CPU 402 may include a single processing unit, or be distributed across one or more processing units in one or more locations (e.g., on a client and server).

Memory 404 includes a known computer readable storage medium, which is described below. In one embodiment, cache memory elements of memory 404 provide temporary storage of at least some program code (e.g., program code 414) in order to reduce the number of times code must be retrieved from bulk storage while instructions of the program code are executed. Moreover, similar to CPU 402, memory 404 may reside at a single physical location, including one or more types of data storage, or be distributed across a plurality of physical systems in various forms. Further, memory 404 can include data distributed across, for example, a local area network (LAN) or a wide area network (WAN).

I/O interface 406 includes any system for exchanging information to or from an external source. I/O devices 410 include any known type of external device, including a display device, keyboard, etc. Bus 408 provides a communication link between each of the components in computer 102, and may include any type of transmission link, including electrical, optical, wireless, etc.

I/O interface 406 also allows computer 102 to store information (e.g., data or program instructions such as program code 414) on and retrieve the information from computer data storage unit 412 or another computer data storage unit (not shown). Computer data storage unit 412 includes a known computer-readable storage medium, which is described below. In one embodiment, computer data storage unit 412 is a non-volatile data storage device, such as a magnetic disk drive (i.e., hard disk drive) or an optical disc drive (e.g., a CD-ROM drive which receives a CD-ROM disk).

Memory 404 and/or storage unit 412 may store computer program code 414 that includes instructions that are executed by CPU 402 via memory 404 to determine social influence and/or predict a geographic location of a key influencer. Although FIG. 4 depicts memory 404 as including program code 414, the present invention contemplates embodiments in which memory 404 does not include all of code 414 simultaneously, but instead at one time includes only a portion of code 414.

Further, memory 404 may include an operating system (not shown) and may include other systems not shown in FIG. 4.

Storage unit 412 and/or one or more other computer data storage units (not shown) that are coupled to computer 102 may store any combination of metrics about social media content 106-1, . . . , metrics about social media content 106-N (see FIG. 1), geographic locations 108-1 (see FIG. 1), . . . , geographic locations 108-N (see FIG. 1), social influence 110-1 (see FIG. 1), . . . , social influence 110-N (see FIG. 1), and forecasted location of key influencer(s) 112 (see FIG. 1).

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to determining social influence and predicting a geographic location of a key influencer. Thus, an embodiment of the present invention discloses a process for supporting computer infrastructure, where the process includes providing at least one support service for at least one of integrating, hosting, maintaining and deploying computer-readable code (e.g., program code 414) in a computer system (e.g., computer 102) including one or more processors (e.g., CPU 402), wherein the processor(s) carry out instructions contained in the code causing the computer system to determine social influence and/or predict a geographic location of a key influencer. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of determining social influence.

While it is understood that program code 414 for determining social influence and/or predicting a geographic location of a key influencer may be deployed by manually loading directly in client, server and proxy computers (not shown) via loading a computer-readable storage medium (e.g., computer data storage unit 412), program code 414 may also be automatically or semi-automatically deployed into computer 102 by sending program code 414 to a central server or a group of central servers. Program code 414 is then downloaded into client computers (e.g., computer 102) that will execute program code 414. Alternatively, program code 414 is sent directly to the client computer via e-mail. Program code 414 is then either detached to a directory on the client computer or loaded into a directory on the client computer by a button on the e-mail that executes a program that detaches program code 414 into a directory. Another alternative is to send program code 414 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 414 is transmitted to the proxy server and then it is stored on the proxy server.

Another embodiment of the invention provides a method that performs the process steps on a subscription, advertising and/or fee basis. That is, a service provider, such as a Solution Integrator, can offer to create, maintain, support, etc. a process of determining social influence and/or predicting a geographic location of a key influencer. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product. The computer program product may include a computer readable storage medium (or media) (memory 404 and computer data storage unit 412) having computer readable program instructions 414 thereon for causing a processor (e.g., CPU 402) to carry out aspects of the present invention.

The computer readable storage medium can be a tangible device that can retain and store instructions (e.g., program code 414) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 414) described herein can be downloaded to respective computing/processing devices (e.g., computer 102) from a computer readable storage medium or to an external computer or external storage device (e.g., computer data storage unit 412) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 414) for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIG. 2 and FIG. 3) and/or block diagrams (e.g., FIG. 1 and FIG. 4) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 414).

These computer readable program instructions may be provided to a processor (e.g., CPU 402) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 412) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 414) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of determining social influence, the method comprising the steps of:
a computer determining measurements of social reach of social media content being sent by mobile devices during an ongoing event that involves multiple individuals using social media via the mobile devices, the measurements of social reach including a rate of proliferation of the social media content;
the computer determining social context features of the mobile devices during the event, the social context features including geographic locations of the mobile devices at times at which the mobile devices send the social media content;
the computer generating a Rayleigh distribution based on the measurements of social reach and the social context features; and
based on the Rayleigh distribution, the computer determining scores indicating respective social influences of the individuals.

2. The method of claim 1, further comprising the steps of:
the computer ranking the social influences of the individuals by ranking the scores; and
based on the ranked social influences, the computer determining an individual included in the multiple individuals is a key influencer during the event, the key influencer being likely to influence actions of other individuals included in the multiple individuals via social media content authored by the key influencer.

3. The method of claim 2, further comprising the step of the computer determining an allocation of a resource during the event, the allocation being based on the individual being the key influencer.

4. The method of claim 1, wherein the step of determining the social context features includes the computer determining an average distance of the mobile devices to an epicenter of activity that is part of the event, the average distance being determined by utilizing a haversine formula.

5. The method of claim 1, further comprising the steps of:
the computer determining measurements of current social reach of the social media content sent by the mobile devices during the event;
the computer forecasting measurements of social reach of the social media content in a future time period;
the computer determining current social context features of the mobile devices during event;
the computer forecasting social context features of the mobile devices in the future time period;
the computer generating four Rayleigh distributions based on (1) the measurements of the current social reach and the current social context features, (2) the forecasted measurements of the social reach and the forecasted social context features, (3) the current social context features and an average of the current and forecasted measurements of the social reach, and (4) the forecasted social context features and the average of the current and forecasted measurements of the social reach, respectively; and
based on the four Rayleigh distributions, the computer determining one or more key influencers and likelihoods of the one or more key influencers being in respective geographic areas at a time included in the future time period.

6. The method of claim 5, further comprising the steps of:
the computer generating a heat map or another visual representation indicating the likelihoods the one or more key influencers are in the respective geographic area at the time included in the future time period; and
the computer determining an allocation of a resource during the event, the allocation being based on the heat map or other visual representation.

7. The method of claim 5, further comprising the step of the computer determining the current and forecasted measurements of the social reach and the current and forecasted social context features are Gaussian distributed and centered at zero, wherein the step of generating the four Rayleigh distributions is in part based on the current and forecasted measurements of the social reach and the current and forecasted social context features being Gaussian distributed and centered at zero.

8. The method of claim 1, further comprising the step of:
providing at least one support service for at least one of creating, integrating, hosting, maintaining, and deploying computer-readable program code in the computer, the program code being executed by a processor of the computer to implement the steps of determining the measurements of the social reach, determining the social context features, generating the Rayleigh distribution, and determining the scores indicating the respective social influences of the individuals.

9. A computer program product, comprising:
a computer-readable storage device; and
a computer-readable program code stored in the computer-readable storage device, the computer-readable program code containing instructions that are executed by a central processing unit (CPU) of a computer system to implement a method of determining social influence, the method comprising the steps of:
the computer system determining measurements of social reach of social media content being sent by mobile devices during an ongoing event that involves multiple individuals using social media via the mobile devices, the measurements of social reach including a rate of proliferation of the social media content;
the computer system determining social context features of the mobile devices during the event, the social context features including geographic locations of the mobile devices at times at which the mobile devices send the social media content;
the computer system generating a Rayleigh distribution based on the measurements of social reach and the social context features; and
based on the Rayleigh distribution, the computer system determining scores indicating respective social influences of the individuals.

10. The computer program product of claim 9, wherein the method further comprises the steps of:
the computer system ranking the social influences of the individuals by ranking the scores; and
based on the ranked social influences, the computer system determining an individual included in the multiple individuals is a key influencer during the event, the key influencer being likely to influence actions of other individuals included in the multiple individuals via social media content authored by the key influencer.

11. The computer program product of claim 10, wherein the method further comprises the step of the computer system determining an allocation of a resource during the event, the allocation being based on the individual being the key influencer.

12. The computer program product of claim 9, wherein the step of determining the social context features includes the computer system determining an average distance of the mobile devices to an epicenter of activity that is part of the event, the average distance being determined by utilizing a haversine formula.

13. The computer program product of claim 9, wherein the method further comprises the steps of:
the computer system determining measurements of current social reach of the social media content sent by the mobile devices during the event;
the computer system forecasting measurements of social reach of the social media content in a future time period;
the computer system determining current social context features of the mobile devices during event;
the computer system forecasting social context features of the mobile devices in the future time period;
the computer system generating four Rayleigh distributions based on (1) the measurements of the current social reach and the current social context features, (2) the forecasted measurements of the social reach and the forecasted social context features, (3) the current social context features and an average of the current and forecasted measurements of the social reach, and (4) the forecasted social context features and the average of the current and forecasted measurements of the social reach, respectively; and
based on the four Rayleigh distributions, the computer system determining one or more key influencers and likelihoods of the one or more key influencers being in respective geographic areas at a time included in the future time period.

14. The computer program product of claim 13, wherein the method further comprises the steps of:
the computer system generating a heat map or another visual representation indicating the likelihoods the one or more key influencers are in the respective geographic area at the time included in the future time period; and
the computer system determining an allocation of a resource during the event, the allocation being based on the heat map or other visual representation.

15. A computer system comprising:
a central processing unit (CPU);
a memory coupled to the CPU; and
a computer readable storage device coupled to the CPU, the storage device containing instructions that are executed by the CPU via the memory to implement a method of determining social influence, the method comprising the steps of:
the computer system determining measurements of social reach of social media content being sent by mobile devices during an ongoing event that involves multiple individuals using social media via the mobile devices, the measurements of social reach including a rate of proliferation of the social media content;
the computer system determining social context features of the mobile devices during the event, the social context features including geographic locations of the mobile devices at times at which the mobile devices send the social media content;
the computer system generating a Rayleigh distribution based on the measurements of social reach and the social context features; and
based on the Rayleigh distribution, the computer system determining scores indicating respective social influences of the individuals.

16. The computer system of claim 15, wherein the method further comprises the steps of:
the computer system ranking the social influences of the individuals by ranking the scores; and
based on the ranked social influences, the computer system determining an individual included in the multiple individuals is a key influencer during the event, the key influencer being likely to influence actions of other individuals included in the multiple individuals via social media content authored by the key influencer.

17. The computer system of claim 16, wherein the method further comprises the step of the computer system determining an allocation of a resource during the event, the allocation being based on the individual being the key influencer.

18. The computer system of claim 15, wherein the step of determining the social context features includes the computer system determining an average distance of the mobile devices to an epicenter of activity that is part of the event, the average distance being determined by utilizing a haversine formula.

19. The computer system of claim 15, wherein the method further comprises the steps of:
the computer system determining measurements of current social reach of the social media content sent by the mobile devices during the event;
the computer system forecasting measurements of social reach of the social media content in a future time period;
the computer system determining current social context features of the mobile devices during event;
the computer system forecasting social context features of the mobile devices in the future time period;
the computer system generating four Rayleigh distributions based on (1) the measurements of the current social reach and the current social context features, (2) the forecasted measurements of the social reach and the forecasted social context features, (3) the current social context features and an average of the current and forecasted measurements of the social reach, and (4) the forecasted social context features and the average of the current and forecasted measurements of the social reach, respectively; and
based on the four Rayleigh distributions, the computer system determining one or more key influencers and likelihoods of the one or more key influencers being in respective geographic areas at a time included in the future time period.

20. The computer system of claim 19, wherein the method further comprises the steps of:
the computer system generating a heat map or another visual representation indicating the likelihoods the one or more key influencers are in the respective geographic area at the time included in the future time period; and
the computer system determining an allocation of a resource during the event, the allocation being based on the heat map or other visual representation.
